(19) United States
(12) Patent Application Publication
(10) Pub. No.: US 2012/0330676 A1
(43) Pub. Date: Dec. 27, 2012

(54) Computer Readable Database Method for Efficient and Effective Delivery of Health Care Products and Services

(76) Inventor: Gary A. Puckrein, Washington, DC (US)

(21) Appl. No.: 13/528,782

(22) Filed: Jun. 20, 2012

Related U.S. Application Data
(60) Provisional application No. 61/499,502, filed on Jun. 21, 2011.

(51) Int. Cl. G06Q 50/22

(52) U.S. Cl. 705/2

(57) ABSTRACT

A method is disclosed for improved the targeting of health care services to selected subpopulations. A user accesses a computer readable database which has data generated from a Bayesian model that predicts prevalence values for various diseases and socio-economic conditions. These data are processed and configured such that prevalence values can be obtained for an array of parameters including both geographic region parameters and demographic characteristics parameters. Due to the statistical analysis, reliable values can be provided for relatively small geographic regions, such as the area bounded by a single zip code. These prevalence values are used in many ways: to target health care services to a selected populations, to assess effects of different interventions, or a single intervention over an extended period of time, and to help efficiently design and locate health care deliver services.

This application relates to and claims priority of Provisional Application Ser No. 61/499,502, filed Jun. 21, 2011, entitled “Database Method for Efficient and Effective Delivery of Health Care Products and Services,” the disclosure of which is incorporated herein by reference as though set forth at length.

### BACKGROUND OF THE INVENTION

In the past, certain health care efforts have been performed with a narrow focus leading to inefficient results and less than optimal effectiveness. For example, determining the optimal location of hospitals, clinics and other health care delivery facilities was carried out independently of the study of distribution of disease (i) geographically within the United States and its Territories and (ii) within the various ethnic groups comprising the population of the United States and its Territories, each of which may have unique disease burdens and health care needs. As a result, hospitals and clinics have often been located with only overall population forecasts in mind. The specific health care needs of the facilities' neighbors were not a prominent consideration. Research into the specific health care needs that arise from an individual's ethnic background was often confined to professional journals. These results have filtered only indirectly to affect the type and location of specific health care services. For example, health care professionals (doctors, administrators, nurses, etc.) have only generally become cognizant of specific health care needs of ethnic populations though various secondary sources. These include medical conferences, medical school resources and through interaction with various other third parties such as sales personnel from pharmaceutical companies, researchers, etc.

This information has only influenced the geographic location of health care delivery when it has filtered, indirectly, out to locations where policy decisions are made. For example, when these professionals participate in a search panel charged with determining the optimal location for a hospital.

One of the advantages of the current disclosure is to uniquely combine these separate efforts. Health care data showing the geographic and demographic distribution of disease, disease indicators, disease costs, treatments and outcomes can be used, directly, to predict optimal geographic locations of specific health care services. In addition, this information can be used to target, for the delivery of health care products and services, specific ethnic populations within a geographic location who are disproportionately affected by the disease. This makes the delivery of health care products and services more effective by reaching the people most in need.

Another shortcoming of traditional methods of collection and utilization of health care data is inefficiency. Data was often collected manually and was labor intensive. Also, this data was collected from third party sources using different data systems and incompatible file formats, (for example, SAS datasets, Access databases, Excel spreadsheets, etc.). The current disclosure improves upon this by creating unique standardization. New data can be entered into a central repository by way of a data content management system. The management system will facilitate standardization of unstructured data formats submitted by third party data providers. The data will then be analyzed under consistent protocols leading to the development and, ultimately, the dissemination of the analyzed data to authorized users.

### BRIEF SUMMARY OF THE INVENTION

Described herein is a system (which includes both a method and internet-based information conduit) for the collection and delivery of health data services. The various embodiments of the invention include capabilities for historic and real-time population health reporting at all geographic levels down to single zip code zones broken down by sex, age and ethnicity, trends analysis and forecasting at all geographic levels by sex, age and ethnicity and facilitation of targeted community health interventions to groups of persons most in need in geographic regions as small as single zip-code zones.

Some of the main goals of the Computer-Readable Database Method for Efficient and Effective Delivery of Health Care Products and Services are: (1) improving the efficiency and effectiveness of the delivery of health care products and services by providing access to a comprehensive on-line warehouse of health data information broken down demographically and geographically (down to the zip code level) to, among others, health care providers, researchers, administrators, insurers and state and federal regulators and legislators; (2) suggesting optimal locations of clinics and other health care facilities and optimal services provided by those clinics and facilities; (3) automating the collection and analysis of health datasets from third party providers; (4) reducing administrative costs associated with existing manual data collection and dissemination efforts; and (5) using the information available from the invention to strengthen and expand health advocacy and data analysis projects designed to reduce disparities in access and quality of health care received by the people of the United States and its Territories.

### BRIEF DESCRIPTION OF THE FIGURES

FIG. 1A shows the prevalence of diabetes in a geographic region such as a state;

FIG. 1B shows data generated by the disclosed methods, specifically prevalence of diabetes at a zip code level;

FIG. 1C is a close up of Cook County, Illinois which shows details of FIG. 1B.

FIG. 2 is a flow diagram illustrating how a disclosed Bayesian model is generated and used.

### DETAILED DESCRIPTION OF THE INVENTION

The following descriptions of preferred embodiments in the disclosure are not intended to be limiting. Persons of skill after reading the disclosure will appreciate that alternative embodiments can be envisioned and practiced.

The system includes a number of on-line indexes focused on particular diseases or socio-economic factors affecting the health status of the population within the United States. Each index will include maps, charts and graphs and reports that can be accessed on line by authorized index users.

For example, a Diabetes Index contains over 30,000 maps, graphs, charts and reports that shows the progression of diabetes in the United States over the last ten (10) years. The data parameters included in the Diabetes Index are broken down geographically at the national, state, county, metropolitan and micropolitan statistical area (“MSA”), federal congressional district, state legislative district and zip code level and demographically by sex, age and ethnicity. There are over 50 data parameters in the Diabetes Index including, but not limited to, prevalence of diabetes and total numbers of diabetics, HbA1C levels of diabetics, costs incurred by diabetics for hospitalizations, ambulatory care, drugs and durable medical equipment, co-morbidities of diabetics including heart and kidney disease, insurance status of diabetics and other information about the socio-economic status of diabetics and their compliance with recommended medical regimens. Unique reports can be produced by authorized users of the Diabetes Index and include reports in narrative form setting out diabetes prevalence and costs for the country and for every state and for every federal congressional and state legislative district within each state. By using the Diabetes Index, heath care agencies and providers will be able to identify, in small geographic areas (zip codes) broken down demographically by age, gender and race/ethnicity, (i) where diabetes disease burdens are concentrated, (ii) how diabetics in these areas consume health care products and services and (iii) the relative outcomes with respect to the care and treatment of the disease. This will allow health care agencies and providers to better design intervention programs targeting diabetics in an effort to improve their outcomes. For example, intervention programs could focus on particular people in an ethnic group who the Diabetes Index shows do not have access to insulin treatment or who do not measure their blood sugar (e.g., HbA1c levels) on the recommended frequency (or at all). Services, including education on the proper care and treatment of diabetes, medication (insulin) and monitoring devices, could then be made available to these people. This would improve their health outcomes and this improvement itself would be measured by the Diabetes Index as it was updated with new data year by year.

In addition to diabetes, indexes focus on other diseases, including, but not limited to, hepatitis C, cardiovascular disease, kidney disease and various types of cancer. Some indexes are not disease-specific, but focus instead on socio-economic factors such as whether people have health insurance. Each index has a unique set of data parameters.

The following objectives offer a road map to describe how development of the system will support the goals set forth above of the Computer-Readable Database Method for Efficient and Effective Delivery of Health Care Products and Services:

The system permits authorized users access to state-of-the-art geographical information system (GIS) reporting capabilities for health care information, including historic and real-time population health reporting at medially relevant geographic levels down to single zip code zones broken down by sex, age and ethnicity, trends analysis and forecasting at all geographic levels by sex, age and ethnicity and facilitation of targeted community health interventions to groups of persons most in need in geographic regions as small as single zip-code zones.

Moreover, the system provides maximum flexibility by allowing authorized users to select from several data subscription subsets that range from standardized data reports to complex customized statistical data queries and GIS maps. Consequently, the system provides an innovative public health surveillance tool for closing health disparities in the United States.

The disclosed system processes users' data report requests instantaneously rather than the days or weeks. When compared to the current business environment, this significantly reduces the length of time for authorized users to acquire health data reports. Moreover, authorized users will have access to their online data subscription services 24 hours a day, 7 days a week.

Improved stakeholder outreach is provided by developing a web-based information portal that highlights the depth and breadth of the health data services available to public and private health care stakeholders. To this end, the system offers a significant marketing channel that supports expansion of the user base.

The disclosure reduces system operating costs by automating processing and dissemination of user data requests. The system significantly limits a need for staff to manually process and disseminate user data requests. Consequently, the system conserves valuable staff time and reduces administrative overhead costs associated with manually processing user data requests.

The disclosure also reduces operating costs by providing a web-based data upload interface for third party data providers. It also increases operating revenue by establishing a data subscription membership service to the system. Revenue generated from user subscription fees are reinvested to: (1) support continuing research efforts to reduce health disparities; (2) strengthen efforts to build public/private partnerships to reduce health disparities; and (3) strengthen and expand the value of the system as a powerful tool for public health surveillance.

Online access to the system automates the various business processes that are currently performed manually. This includes both internal and external health data sharing. The development of web-based access to the system simplifies user access to the system's unique integration of chronic disease datasets and state-of-the-art GIS reporting.

The system also provides third party data providers with an efficient and automated dataset upload functionality that capitalizes on the latest web-based encryption technology to maintain the confidentiality of sensitive data. Furthermore, a web-based solution will greatly improve the manner in which staff performs their internal health data analysis and management functions.

Rather than mailing, faxing or phoning in data query requests, users visit a website via their work or home computer systems, browse data subscription offerings, and then select health data report subscriptions that meet their specific professional needs. Data subscription registration will be simplified for users by allowing users to enter account information directly into the system via an intuitive web form. Upon receiving account and payment confirmation, a user obtains a system generated customer ID and password that can be used to access the system at any time to review account information, modify or cancel a subscription, obtain subscriptions to additional index products, submit inquiries, generate, print or save health data report queries, and then maintain a personal archive of downloaded reports.

Third party data providers use automated data exchange functionality to upload their datasets directly to the system repository. Third party data providers voluntarily request a user ID and password to access the system. However, third party providers have their system use limited to an upload page and data submission status report. In contrast to using unprotected email and postal mail, the system dataset upload page functionality will provide third party data providers with an efficient and secure means for submitting highly confidential clinical datasets. The data submission status report page will also notify third party data providers when a user has requested dataset corrections.

Finally, staff will benefit from new system automation in fulfilling their data analysis and administrative functions. For example, system administrative user accounts are established for staff to allow them to perform various administrative functions such as system file maintenance, user account management, billing, user inquiry resolution, subscription data report distribution, and internal health data report exchange. The end result will be a significantly improved user experience, reduced manual data processing workload, and an efficient use of limited administrative resources and valuable staff time.

Critical success factors are business issues that are central to the ultimate success of any new system. The following critical success factors have been identified for the system.

First, the service provider should maintain a consistent flow of health data sources through data use agreements with existing and new third party entities. Data sharing relationships can be formed, for example through third party agreements, with states, federal agencies, drug companies and private insurance providers. Consequently, the inventor has assembled a comprehensive baseline of zip code level health data from which he has developed an online health data reporting system broken down by geography (to the zip code level) and demographically (by sex, age and ethnicity). However, to ensure the long-term success of this system, it is important that these efforts continue; in particular, acquiring additional up-to-date health data through agreements with the third party data providers.

Through complex statistical analysis by highly trained statisticians (PhD level), the data can be broken into any geographical area including zip code, congressional district, state legislative district, county, state, MSA, etc. This allows users to extract quickly data that may be difficult to compile otherwise.

Any disease or death data can be used and any International Classification of Diseases (“ICD”) classified condition can be included in the datasets. Note, the ICD is designed to promote international comparability in the collection, processing, classification, and presentation of disease and mortality statistics. This includes providing a format for reporting on diseases and on causes of death on the death certificate. The reported conditions are then translated into medical codes through use of the classification structure and the selection and modification rules contained in the applicable revision of the ICD, published by the World Health Organization. These coding rules improve the usefulness of disease and mortality statistics by giving preference to certain categories, by consolidating conditions, and by systematically selecting a single disease or cause of death from a reported sequence of conditions. For deaths, the single selected cause for tabulation is called the underlying cause of death, and the other reported causes are the non-underlying causes of death. The combination of underlying and non-underlying causes is the multiple causes of death.

Using the accumulated data a user generates various reports. A “rankings tool” ranks results after certain parameters are selected. For example, the user selects a parameter (e.g., diabetes prevalence), a year (e.g., 2010), a geography (e.g., State), a demography (e.g., black) and a number of records (e.g., 10). After these selections have been made, the user hits a Submit button. This brings up a list in printable format of the top 10 States with the highest diabetes prevalence among blacks in 2010.

Another feature of the disclosure is a clinical trials tool. A user selects a geography: either a State, a zip code or any aggregation of small geographic regions such as zip codes. This results in a list, in printable format, of all diabetes clinical trials in the selected geography with some identifying information including sponsor, city, state and zip code. More detailed information about any listed clinical trial can be accessed if the user clicks on that trial.

Still another feature of the disclosure is a clinical trials locator. When accessed, a layer of information in the form of, for example, “red” circles with a number in the center appears on a map. This map displays the number of diabetes clinical trials in the geographic vicinity of the red circle. When the red circle is selected a list of these trials with some identifying information including type, sponsor and zip code is displayed. More detailed information about any listed clinical trial can be accessed if the user selects that display.

Yet another feature is a clinician locater. A clinician specialty (e.g., Family Practice) can be selected. This brings up a layer of information on a map in the form of, for example, “blue” circles with a number in the center, which is the number (in this example) of Family Practice Clinicians in the geographic vicinity of the blue circle. A list of these clinicians with some identifying information including zip code is displayed. As explained above, more detailed information about any listed clinician can be accessed if the user selects that clinician.

The various methods and devices described herein foster new data sharing relationships with other key third party sources of health care data. Although many third party sources have been successfully used, one embodiment of the current disclosure will allow new opportunities to foster data sharing relationships with other important third party entities that possess health care data of interest. For example, other key sources of health care data include private/public hospitals, local/state health departments (not currently reporting to the inventor), health-related state associations, and national health interest groups with a vital interest in improving the health of various ethnic groups and Americans as a whole. The acquisition of data from these other sources will serve to strengthen the system and its reputation as the most comprehensive national source of health care data.

The disclosure includes maintenance of a well-organized health care data warehouse infrastructure that supports the standardization of system data output. It is critical to maintain a consolidated warehouse of health care data to support the system infrastructure. Because most of the data collected from third party sources are derived from disparate data systems and inconsistent file formats (e.g., SAS datasets, Excel, Access, etc.), the system's success depends upon maintaining a data content management system that facilitates the standardization of unstructured data formats submitted by third party data providers.

### EXAMPLES

The following are some preferred embodiments of the disclosed invention.

Example 1. A health care provider wanting to open a clinic can obtain the optimal location of a clinic as follows. A provider selects certain health care services of concern to the provider, for example diabetes. The database contains certain relevant data, such as diabetes prevalence. The provider selects various parameters such as year (for example 2010), geography (for example a zip code), demographics (for example blacks). The system will generate a list of the top 10 zip codes with the highest diabetes prevalence among blacks in 2010.

Example 2. A health care patient seeks ongoing treatment for a particular disease. Using the invention, the patient's health care provider selects clinical trials relevant to the patient's disease as well as the geographic location of that clinical trial.

Example 3. Optimized Health Insurance. By obtaining and using certain data on the population being covered, the invention will identify certain patterns that, in turn, suggest cost saving options. For example, a population having certain high disease prevalence can be offered, and even encouraged with rebates to take advantage of, relevant prophylactive services. This will lead to better health for the customer at a lower overall cost to the insurance provider.

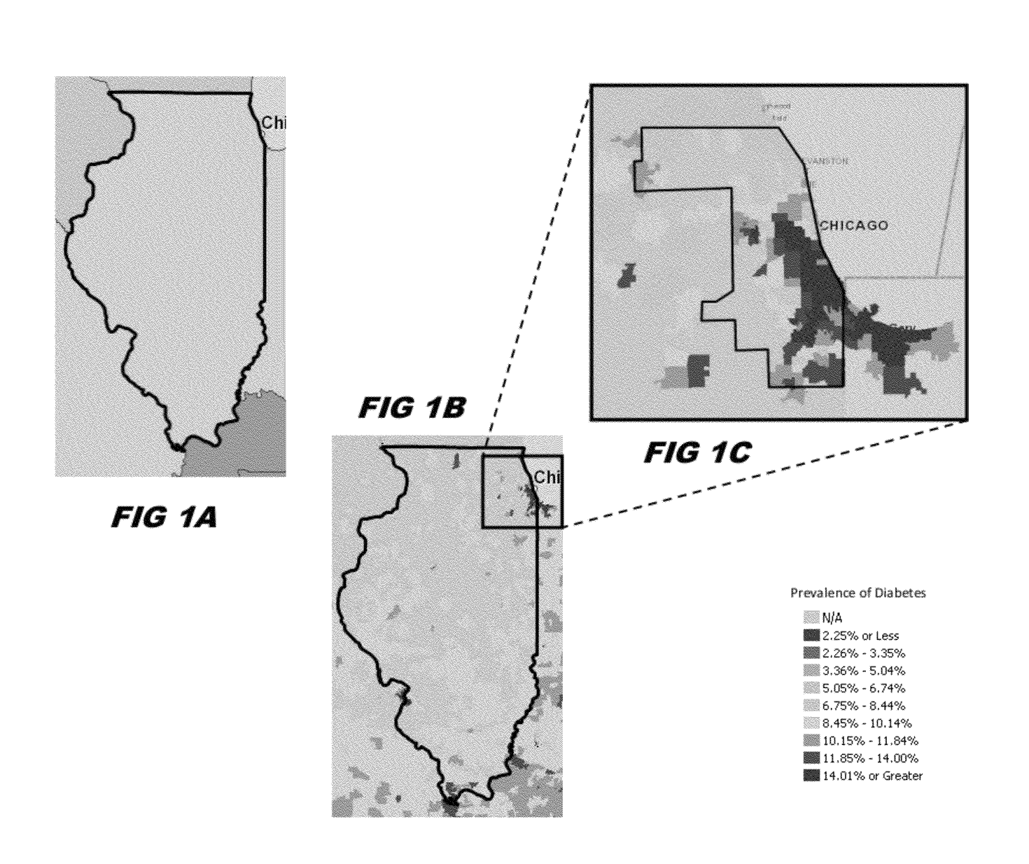

Example 4. A further example of the disclosed methods will be illustrated, first in graphic form, then using numeric examples. FIG. 1A illustrates typical raw data, the statewide prevalence of a disease, in this example, diabetes. For purposes of this illustration it is sufficient to indicate prevalence with black and white shading. Note, however, that in black and white very low prevalence can be confused with very high prevalence, because both show up as “dark.” In the actual practice, the confusion would be resolved either by rendering the prevalence shading in color. For example, the “dark” low levels would be dark green and the “dark” high levels would be dark red. Alternatively the shading can be adjusted so that low to high is simply light to dark.

FIG. 1B shows the results after the raw data is processed according to the disclosure. Note the high prevalence in the upper right hand portion of Illinois. FIG. 1C is a close up of this region, showing diabetes prevalence data for individual zip codes in Cook County, Illinois.

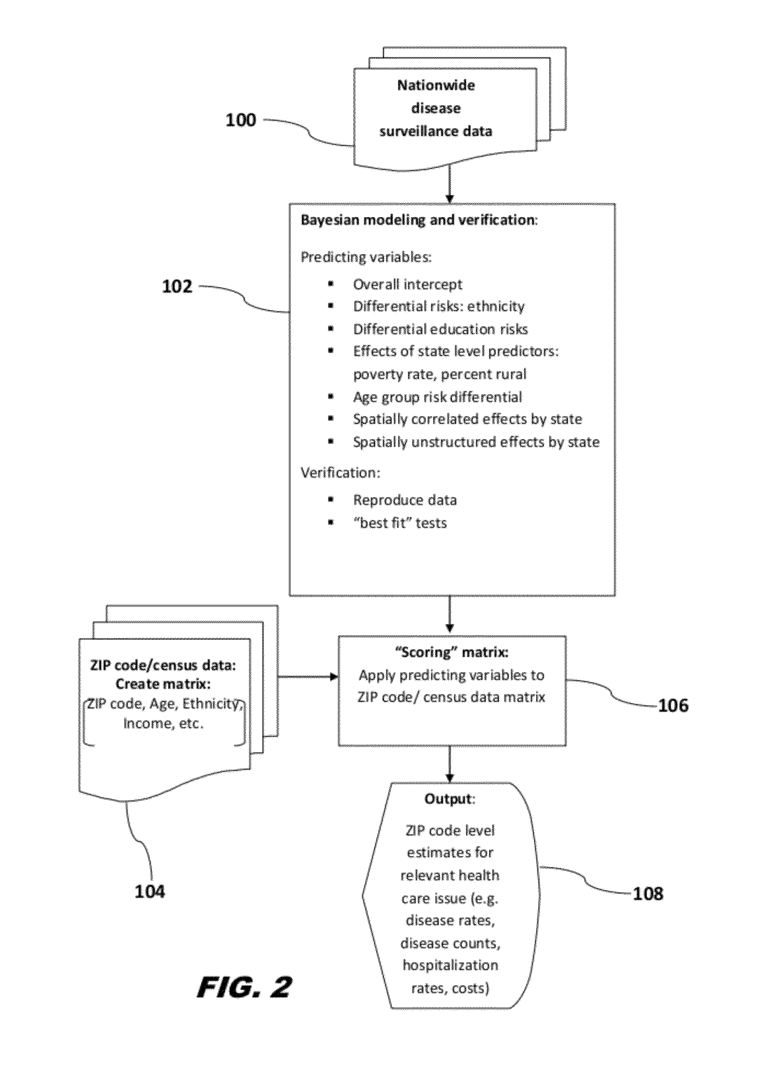

FIG. 2 shows a preferred process, in flow chart format, by which raw data is processed. Data is gathered, for example, by way of a survey 100. While specific individuals are surveyed, due to privacy concerns the survey results will not contain any specific personal data. Surveys can be those regularly carried out by government agencies or specialized surveys commissioned by private parties. An example is the set of US-wide Behavioral Risk Factor Surveillance System, or BRFSS surveys. The BRFSS surveys are run by the Centers for Disease Control (CDC). It is a state-based system of health surveys that generate information about health risk behaviors, clinical preventive practices, and health care access and use primarily related to chronic diseases and injury. As shown in FIG. 2, this data undergoes extensive statistical processing 102. The survey data is processed using a computer implemented Bayesian hierarchical regression model, developed in ascertaining the effects of demographic variables. Predicting variables are tested, such as ethnicity, education, poverty rate, the neighborhood's degree of rural character, age group, spatially correlated state effects and spatially unstructured state effects. The resulting models are then verified 102. Typical verification tests are how well the model can reproduce the data. Also candidate models are compared using “Best Fit” tests.

These results are then further processed with a goal of building a comprehensive set of computer readable data that can be used to provide statistically sound estimates on the various health care related issues discussed above. Census data, such as zip codes, age, ethnicity, income, etc., are gathered 104. These data are then combined with data from the Bayesian modeling 106. The end result is a comprehensive set of data that can provide statistically sound estimates of a variety of health care and health care related issues. For example, the database can provide disease rates, disease counts, rates of hospitalization and the cost of that hospitalization 108. Note that this information is far more detailed, and thus more useful than what could be reasonably ascertained just by a review of raw survey results.

Using numeric examples this process can be illustrated as follows. First health care data is gathered, for example, in the form of a survey. Due to privacy concerns, the survey does not identify any specific individual. Typical survey data is shown in Table 1.

TABLE 1
Raw survey data.

| | State | | | | | | | | | | |
|---|---|---|---|---|---|---|---|---|---|---|---|
| | FIPS | Geographic | Household | Pre-call | Replicate | Replicate | | Interview | Interview | Interview | Interview |
| No. | code | stratum | density | status | number | depth | File Month | date | month | day | Year |
| 1 | 1 | 9 | 2 | 1 | 120127 | 25 | 12 | 12302010 | 12 | 30 | 2010 |
| 2 | 1 | 13 | 1 | 1 | 10170 | 26 | 1 | 02022010 | 02 | 02 | 2010 |
| 3 | 1 | 17 | 2 | 1 | 80197 | 23 | 8 | 08182010 | 08 | 18 | 2010 |
| 4 | 1 | 4 | 1 | 1 | 100041 | 19 | 10 | 11012010 | 11 | 01 | 2010 |
| 5 | 1 | 13 | 1 | 1 | 120172 | 28 | 12 | 12302010 | 12 | 30 | 2010 |
| 6 | 1 | 8 | 2 | 1 | 100106 | 3 | 10 | 10082010 | 10 | 08 | 2010 |
| 7 | 1 | 2 | 2 | 1 | 70017 | 29 | 7 | 07232010 | 07 | 23 | 2010 |
| 8 | 1 | 14 | 1 | 1 | 110176 | 1 | 11 | 11302010 | 11 | 30 | 2010 |
| 9 | 1 | 14 | 1 | 1 | 120177 | 11 | 12 | 12302010 | 12 | 30 | 2010 |

As described above, the survey data is processed using a Bayesian hierarchical regression model, developed in ascertaining the effects of demographic variables AGE, RACE, EDUCATION, COUPOV, and STATE on predicting diabetes outcomes with or without the impact of specific interventions. A sample of the modeling result is presented in Table 2.

TABLE 2
Parameter estimates from the Bayesian hierarchical regression model

| | | | | | | | | | |
|---|---|---|---|---|---|---|---|---|---|
| | am | −4.819 | | | | | | | |
| race | bm(1) to bm(4) | 0.000 | 0.562 | 0.561 | 0.600 | | | | |
| age | cm(1) to cm(13) | 0.000 | 0.062 | 0.643 | 0.912 | 1.651 | 2.213 | 2.418 | 2.927 |
| edu | dm(1 to dm(4) | 0.000 | −0.166 | −0.128 | −0.440 | | | | |
| pov | em(1) | 0.4578 | | | | | | | |
| rural | fm(1) | −0.020 | | | | | | | |
| St | gm(1) to gm(54) | 0.058 | 0.004 | 0.209 | 0.166 | −0.201 | −0.109 | 0.132 | −0.003 |
| | af | −4.302 | | | | | | | |
| | bf(1) to bf(4) | 0.000 | 1.003 | 0.613 | 0.524 | | | | |
| | cf(1) to cf(13) | 0.000 | 0.000 | 0.377 | 1.115 | 1.351 | 1.596 | 2.002 | 2.421 |
| | df(1) to df(4) | 0.000 | −0.423 | −0.525 | −0.961 | | | | |
| | ef(1) | 0.4578 | | | | | | | |
| | ff(1) | 0.026 | | | | | | | |
| St | gf(1) to gf(54) | 0.115 | 0.052 | −0.001 | 0.024 | −0.293 | −0.053 | −0.023 | −0.272 |

The database is configured to derive zip code level estimates for certain health conditions as follows. First zip codes and demographic variables derived from census data are stored in a spread sheet as shown in Table 3.

TABLE 3

| st | pov | rur | m_edu1 | m_edu2 | m_edu3 | m_edu4 | f_edu1 | f_edu2 | f_edu3 | f_edu4 |
|---|---|---|---|---|---|---|---|---|---|---|
| 5 | 0.14 | 0 | 0.171 | 0.285 | 0.296 | 0.248 | 0.180 | 0.222 | 0.326 | 0.271 |
| 5 | 0.05 | 0 | 0.099 | 0.275 | 0.395 | 0.232 | 0.098 | 0.281 | 0.380 | 0.241 |
| 5 | 0.13 | 1 | 0.169 | 0.334 | 0.322 | 0.175 | 0.195 | 0.282 | 0.348 | 0.175 |
| 5 | 0.07 | 0 | 0.117 | 0.294 | 0.374 | 0.215 | 0.131 | 0.263 | 0.384 | 0.221 |
| 5 | 0.05 | 0 | 0.120 | 0.248 | 0.343 | 0.289 | 0.102 | 0.258 | 0.341 | 0.299 |
| 5 | 0.08 | 0 | 0.099 | 0.292 | 0.405 | 0.205 | 0.120 | 0.291 | 0.388 | 0.200 |
| 5 | 0.08 | 0 | 0.180 | 0.087 | 0.471 | 0.262 | 0.029 | 0.405 | 0.406 | 0.161 |
| 5 | 0.04 | 1 | 0.044 | 0.428 | 0.428 | 0.100 | 0.078 | 0.415 | 0.404 | 0.102 |
| 5 | 0.07 | 1 | 0.314 | 0.324 | 0.291 | 0.071 | 0.305 | 0.498 | 0.138 | 0.059 |
| 5 | 0.22 | 1 | 0.418 | 0.355 | 0.146 | 0.082 | 0.375 | 0.394 | 0.104 | 0.127 |
| 5 | 0.05 | 1 | 0.479 | 0.305 | 0.113 | 0.103 | 0.250 | 0.387 | 0.111 | 0.253 |
| 5 | 0.08 | 0 | 0.180 | 0.087 | 0.471 | 0.262 | 0.029 | 0.405 | 0.406 | 0.161 |

The output data is then copied and saved to a new worksheet and merged with the health care condition prevalence estimates to create a spreadsheet containing geographic region estimates of health care condition prevalence. Table 4 shows an example for zip code area estimates of diabetes prevalence.

TABLE 4

| zip | st | Male | Fem | Pers | WNH | BNH | HISP | OTH | Age18t49 |
|---|---|---|---|---|---|---|---|---|---|
| 86544 | AZ | 0.1679 | 0.1693 | 0.1684 | 0.1194 | 0.2050 | 0.1780 | 0.1687 | 0.0703 |
| 86545 | AZ | 0.1591 | 0.1380 | 0.1481 | 0.1038 | 0.1807 | 0.1563 | 0.1484 | 0.0602 |
| 86547 | AZ | 0.1868 | 0.1889 | 0.1876 | 0.1343 | 0.2263 | 0.1976 | 0.1877 | 0.0804 |
| 86549 | AZ | 0.1834 | 0.1783 | 0.1805 | 0.1296 | 0.2194 | 0.1913 | 0.1818 | 0.0766 |
| 86556 | AZ | 0.1742 | 0.1691 | 0.1714 | 0.1226 | 0.2093 | 0.1820 | 0.1728 | 0.0719 |
| 89024 | AZ | 0.0879 | 0.0811 | 0.0843 | 0.0770 | 0.1391 | 0.1190 | 0.1126 | 0.0315 |
| 90001 | CA | 0.1554 | 0.1777 | 0.1666 | 0.1090 | 0.1894 | 0.1639 | 0.1552 | 0.0696 |
| 90002 | CA | 0.1564 | 0.1805 | 0.1685 | 0.1075 | 0.1870 | 0.1617 | 0.1532 | 0.0706 |
| 90003 | CA | 0.1573 | 0.1830 | 0.1702 | 0.1089 | 0.1893 | 0.1637 | 0.1551 | 0.0715 |
| 90004 | CA | 0.1235 | 0.1252 | 0.1242 | 0.0878 | 0.1566 | 0.1344 | 0.1271 | 0.0491 |
| 90005 | CA | 0.1378 | 0.1390 | 0.1382 | 0.0954 | 0.1684 | 0.1450 | 0.1373 | 0.0556 |
| 90006 | CA | 0.1475 | 0.1615 | 0.1544 | 0.1043 | 0.1824 | 0.1575 | 0.1491 | 0.0634 |
| 90007 | CA | 0.1369 | 0.1452 | 0.1410 | 0.0992 | 0.1743 | 0.1503 | 0.1424 | 0.0571 |

This example is, of course, a mere sample of the statistical analysis and the data processing required. In practice, a much larger and much more comprehensive database is utilized. In the case of diabetes, for example, the database will not only indicate a geographic region where diabetes disease burdens are concentrated but also indicate how diabetics in these areas consume health care products and services and the relative outcomes with respect to the array of different care and treatments diabetes patients have received.

The database will reflect outcomes for variables such as: poor access to insulin treatment and failure to measure blood sugar (e.g., HbA1c levels) at the recommended frequency. The database will also measure the effects of Services, such as education on the proper care and treatment of diabetes, medication (insulin) and monitoring devices. Because the database would be updated with new data, year after year, the effects of any of the interventions can be monitored using longitudinal studies.

While diabetes is used in these examples, the computer readable database is intended to cover all health conditions including: hepatitis C, cardiovascular disease, kidney disease and various types of cancer, etc.

The database is not limited to diseases and assessing disease treatments. Any relevant socio-economic factor can be analyzed as well as interventions designed to affect the socio-economic factor. For example, analysis can be performed based on the prevalence of health insurance coverage. Various geographic and demographic factors can be shown to affect health insurance coverage. Various “interventions” can be tested and monitored from year to year. In this way one can carry out a longitudinal study to analyze the most effective way to increase health and the incidence of health insurance coverage.

The terms “prevalence” and “prevalence value” as used in the following claims include not only to frequency data but also to counts or whole number data.

In describing the invention, reference has been made to preferred embodiments. Those skilled in the art, however, and familiar with the disclosure of the subject invention, may recognize additions, deletions, substitutions, modifications and/or other changes which will fall within the scope of the invention as defined in the following claims.

What is claimed is:

1. A method of improved targeting of health care services to selected subpopulations comprising:
accessing a user interface which has a connection to a computer readable database, said database having:
a tested and verified Bayesian model that predicts prevalence values for a health condition as a function of selected parameters;
a set of indexed parameters including geographic region parameters and demographic characteristics parameters, and
said computer readable database is configured to generate a prevalence value in response to a parameter selection, and
entering into said user interface a query which includes one or more geographic parameters and one or more demographic parameters relevant to targeting health care services to a selected subpopulation; and
receiving a response to said query with health care prevalence values corresponding to the parameters and said prevalence values are used to target health care services to a selected population.

2. The method of improved targeting of health care services as defined in claim 1 and further comprising:
said health condition is selected from the group consisting of diabetes, hepatitis C, cardiovascular disease, kidney disease and all types of cancer.

3. The method of improved targeting of health care services as defined in claim 1 and further comprising:
said demographic parameters are selected from the group consisting of sex, age range, ethnicity, income range, education level, education range, local population density and degree of rural versus urban character.

4. The method of improved targeting of health care services as defined in claim 1 and further comprising:
said geographic parameters are selected from the group consisting of zip code region, county, city, state legislative district, federal legislative district, local government district, suburban area and greater metropolitan area.

5. The method of improved targeting of health care services as defined in claim 1 and further comprising:
a health care intervention is applied and, after said computer readable database is updated, said method steps are repeated in order to measure the effects of the intervention.

6. The method of improved targeting of health care services as defined in claim 1 and further comprising:
said response to said query is used to target the location of a health care delivery service.

7. The method of improved targeting of health care services as defined in claim 1 and further comprising:
said response to said query is used to offer health insurance custom designed to take into account the health care service.

8. A method of improved targeting of health care services to selected subpopulations comprising:
accessing a user interface which has a connection to a computer readable database, said database having:
a tested and verified Bayesian model that predicts prevalence values for a socio-economic condition as a function of selected parameters;
a set of indexed parameters including geographic region parameters and demographic characteristics parameters, and
said computer readable database is configured to generate a prevalence value in response to a parameter selection, and
entering into said user interface a query which includes one or more geographic parameters and one or more demographic parameters relevant to targeting health care services to a selected subpopulation; and
receiving a response to said query with health care prevalence values corresponding to the parameters and said prevalence values are used to target health care services to a selected population.

9. The method of improved targeting of health care services as defined in claim 8 and further comprising:
said socio-economic condition is health insurance coverage.

10. The method of improved targeting of health care services as defined in claim 8 and further comprising:
said steps of entering a query and receiving a response are repeated at regular intervals after the database is updated.

11. The method of improved targeting of health care services as defined in claim 8 and further comprising:
a health care intervention is applied and, after said computer readable database is updated, said method steps are repeated in order to measure the effects of the intervention.

12. The method of improved targeting of health care services as defined in claim 8 and further comprising:
said response to said query is used to target the location of a health care delivery service.

13. The method of improved targeting of health care services as defined in claim 8 and further comprising:
said response to said query is used to offer health insurance custom designed to take into account the health care service.

14. A method of targeting health care intervention to selected subpopulations comprising:
(a) selecting a health condition of interest;
(b) obtaining health condition surveillance data including disease information and demographic characteristics;
(c) executing a computer program which performs Bayesian analysis on disease surveillance data to obtain a plurality of Bayesian models;
(d) verifying one or more Bayesian models for accuracy;
(e) obtaining census data;
(f) using said Bayesian models together with the census data to predict disease prevalence values in selected subpopulations; and
(g) using the disease prevalence values to target appropriate health care intervention to said selected subpopulations.

15. The method of improved targeting of health care services as defined in claim 14 and further comprising:
said health condition of interest is selected from the group consisting of diabetes, hepatitis C, cardiovascular disease, kidney disease and all types of cancer.

16. The method of improved targeting of health care services as defined in claim 14 and further comprising:
said demographic characteristics are selected from the group consisting of sex, age range, ethnicity, income range, education level, education range, local population density and degree of rural versus urban character.

17. The method of improved targeting of health care services as defined in claim 14 and further comprising:
said census data are selected from the group consisting of zip code region, county, city, state legislative district, federal legislative district, local government district, suburban area and greater metropolitan area.

18. The method of improved targeting of health care services as defined in claim 14 and further comprising:
a health care intervention is applied and, after said computer readable database is updated, said method steps are repeated in order to measure the effects of the intervention.

19. The method of improved targeting of health care services as defined in claim 14 and further comprising:
said response to said query is used to target the location of a health care delivery service.

20. The method of improved targeting of health care services as defined in claim 14 and further comprising:
said response to said query is used to offer health insurance custom designed to take into account the health care service.
